(19) United States
(12) Patent Application Publication
(10) Pub. No.: US 2022/0035473 A1
(43) Pub. Date: Feb. 3, 2022

(54) Device, Means of Transport and Method for Operating a Digitizer

(71) Applicant: Bayerische Motoren Werke Aktiengesellschaft, Muenchen (DE)

(72) Inventors: Florian MIEDL, Moosburg an der Isar (DE); Thomas TILLE, Muenchen (DE)

(21) Appl. No.: 17/280,462

(22) PCT Filed: Aug. 5, 2019
(86) PCT No.: PCT/DE2019/100709

§ 371 Date: Mar. 26, 2021

(30) Foreign Application Priority Data
Sep. 27, 2018 (DE) 10 2018 216 555.6

(51) Int. Cl. G06F 3/041; G06F 1/3234; B60K 37/02; G06F 1/3231

(52) U.S. Cl. CPC G06F 3/0416; G06F 1/3262; B60K 37/02; G06F 3/0412; G06F 1/3231; G06F 3/044; B60K 2370/1438; B60K 2370/52; B60K 2370/774; B60K 2370/782; B60K 2370/794; B60Y 2200/11

(57) ABSTRACT

A device for the operation of a digitizer includes a data input, an evaluation unit, and a data output. The evaluation unit is configured, in connection with the data input, to ascertain an approach by an input medium toward the digitizer without contact with the digitizer via an optical sensor. The evaluation unit is configured to transition the digitizer, in connection with the data output and in response to the data input, from a sleep mode to an operating mode.

### BACKGROUND AND SUMMARY OF THE INVENTION

The present subject matter relates to an apparatus, to a means of transport, and to a method for operating a digitizer. The present subject matter also relates to a method for the requirement-driven supply of power to a digitizer in a manner such that the power outlay for operating the digitizer can be reduced.

Touchscreens receive users' touch inputs and make possible a GUI-specific function call. In touchscreens that are permanently supplied with electric power (e.g. doorbell systems and touchscreens in means of transport), the touch-sensitive input surfaces (“digitizers”) are permanently supplied with electric power such that they are available for receiving user inputs independently of a utilization state. The result is that electric power is consumed by the digitizer even in the standby mode or in time intervals without user inputs.

DE 10 2013 222 940 A1 discloses an operating unit having a capacitive sensor provided for detecting a user approaching a keypad of a user interface. If the capacitive sensor unit detects the approach, a first control unit activates the keypad. In this way, the keypad can be activated from a sleep mode by a movement, and, at the same time, a user input can be made by means of the keypad. In this way, the consumption of standby current by the user interface can be reduced.

DE 10 2017 106 450 A1 discloses a dynamic setting of a touch-sensitive region in a display arrangement. An approach by a first user can be distinguished from an approach by a second user via an optical/acoustic transceiver. The first or second user is captured via the reflection at the finger of the user and capturing the returning signal or echo.

For battery-operated touchscreens, a permanent supply of power is not expedient because this would cause the mobility of the user interface to decrease. A push of a button or another touch-based input by a user is therefore needed to wake the digitizer from a standby state/sleep state and to transition it into an operational state with increased power consumption (operating mode). The required user input before the digitizer is actually operated results in an inconvenience and in delays during function accessing.

The object of the present subject matter is achieved by a method for operating a digitizer of a user interface. The digitizer can be understood to mean a touch-sensitive surface that makes localization of a touch-based user input possible. Such digitizers have a transparent design to make screens that are located behind them capable of being operated via touch-based user inputs. In a first step, an approach by an input medium to the digitizer is ascertained without contact with the digitizer. For example, a sensor may be used to ascertain that the finger of a user has a predefined proximity to the digitizer without the finger already touching the digitizer. This can be ascertained, for example, using a separate sensor. In particular, the presence of an input medium in a rectangularly designed cuboid of predefined depth located in front of the digitizer can be ascertained using a sensor. The predefined proximity can range from 1 mm to 30 cm or more. In the context of the present application, in particular all integer centimeter spacings are to be disclosed as possible range limits for the predefined proximity. As a reaction to the approach being ascertained by means of an optical sensor, the digitizer switches from a sleep mode into an operating mode. The sleep mode exhibits a reduced power consumption on the part of the digitizer as compared to the operating mode. In other words, a supply of power to the digitizer in the sleep mode is lower than in the operating mode. In the reverse, a supply of power to the digitizer in the operating mode is higher than in the sleep mode. The switch from the sleep mode into the operating mode occurs automatically as a reaction to the predefined proximity of the input medium being reached or undershot. In particular, the predefined proximity can be ascertained owing to the input medium entering the cuboid space located in front of the digitizer. In this case, a surface of the digitizer can represent or coincide with a projection surface or surface of the cuboid space. Due to the fact that the digitizer changes from the sleep mode into the operating mode only as a response to the input medium approaching, the power consumption in the sleep mode can be considerably lower, independently of an operating state of an associated screen. In this way, the mobility (battery time) of a mobile user interface can be increased according to the present subject matter. In this case, too, the power consumption by a user interface that is supplied generatively with power or by a user interface that is supplied by an onboard electrical system/power system can be reduced and resources can be saved. If the method according to the present subject matter is performed in a means of transport, the CO₂ emission of the means of transport can be reduced.

The sleep mode can be, for example, a state in which power consumption is less than 1 watt. In particular, the sleep mode can be a state without any power consumption by the digitizer. In other words, the digitizer is switched off in the sleep mode. In particular, the digitizer is not configured to capture the input medium. Localization of the input medium on the part of the digitizer is therefore optionally excluded in the sleep mode. In this way, a user interface according to the present subject matter can be realized particularly energy-efficiently. The approach by the input medium toward the digitizer can be captured via a separate proximity sensor. For example, the proximity sensor can be configured as an infrared sensor. In this context, an infrared light source can ensure that the signature of the input medium has sufficient intensity in the infrared frequency range. Alternatively, or additionally, a capacitive proximity sensor can be used. Alternatively, or additionally, the approach by the input medium can be captured by means of an optical camera. Any sensor system that is suitable for a proximity sensor system can, according to the present subject matter, additionally be used for ascertaining the approach by the input medium. It is thus not necessary for the digitizer itself to capture the approach.

The abovementioned statements do not rule out that, behind the digitizer operated according to the present subject matter, a screen is arranged that can be visually detected by a user located on the other side of the digitizer. In this regard, the digitizer can have a transparent design. In particular, the user inputs on the digitizer can refer to a user interface presented on the screen. In this case, the positions on the digitizer that the input medium touches are matched to positions on the screen or on the graphical user interface that is presented thereon. If this is provided for operating the user interface, the activation of the screen can also take place as a reaction to the abovementioned approach. The power consumption of the user interface can thus be reduced further.

A screen behind the digitizer, however, is certainly not necessary in accordance with the present subject matter. The digitizer can also be arranged as an input surface of subtle design on or behind a decorative surface. For example, the decorative surface may be the surface of a vehicle interior. Even here, the digitizer can have a transparent design so as not to distort the visual impression of the decorative surface, if possible. The decorative surface can comprise, for example, wood and/or carbon and/or plastic and/or metal. If the digitizer is arranged behind the surface of the vehicle interior, it may have a non-transparent design and/or a capacitive mode of action. User inputs on the digitizer can thus be received and used for function calls. The user inputs can optionally also be used for operating a screen that is located elsewhere.

A particularly flexible arrangement of a digitizer according to the present subject matter can be attained by a curved surface. In other words, the digitizer can be applied on curved surfaces by having a curved shape itself or by being given a curved shape due to this application. The shape can be concave and/or convex, for example. This gives a particularly great number of possible positions for arranging the digitizer for example in an interior of a means of transport.

The proximity sensor used for capturing the approach can be arranged at a suitable location. A spatial proximity to the digitizer is here not absolutely necessary. For example, when arranging the digitizer in a means of transport, the proximity sensor can be arranged in a dashboard and/or in a roof module and/or in a center console and/or in a multifunction steering wheel and/or in a door's interior trim. The abovementioned positions can also be selected for the digitizer itself, independently of the position of the proximity sensor.

According to the present subject matter, an apparatus for the operation of a digitizer is proposed. The apparatus comprises a data input, an evaluation unit, and a data output. The data input can also be embodied as an input for signals of the proximity sensor, which means that the apparatus can capture the approach by the input medium toward the digitizer via a sensor that is connected for information transfer. The evaluation unit can be designed as a programmable processor, microprocessor, microcontroller, electronic control device, application-specific integrated circuit (ASIC), field-programmable gate array (FPGA), and the like. A data output of the apparatus is configured to transition at least the digitizer from sleep mode into the operating mode (and back). The evaluation unit is configured, in connection with the data input, to ascertain the approach by the input medium toward the digitizer without contact with the digitizer. The evaluation unit is further configured, in connection with the data output, to transition, as a reaction thereto, the digitizer from sleep mode into the operating mode. In this case, the power consumption by the digitizer is increased, and in particular the ability thereof to spatially resolve touch-based user inputs is also improved/established. In other words, during the transition from sleep mode into the operating mode, the digitizer is prepared to communicate, ideally without delay, touch-based user inputs and to make them able to be located. In this way, the apparatus according to the present subject matter is configured to correspondingly realize the features, combinations of features, and the resulting advantages of the method noticeably such that reference is made to the above statements to avoid repetitions.

According to the present subject matter, a means of transport (e.g. a passenger car, transporter, truck, motor bicycle, aircraft and/or watercraft) having an apparatus according to the present subject matter is proposed. The digitizer in this case is preferably to be understood to mean a user interface that is permanently installed in the means of transport. The digitizer can be installed in combination with a screen as a touchscreen and/or independently of a screen in the interior of the means of transport. In particular, the digitizer can be provided in the dashboard and/or in a center console and/or in a multifunction steering wheel and/or in a door's interior trim and/or in a roof operating module of the means of transport.

In addition, the apparatus according to the present subject matter can be provided in a portably user device. The portable user device can be embodied in the form of a wireless communication apparatus.

### BRIEF DESCRIPTION OF THE DRAWINGS

FIG. 1 shows a plan view and a sectional view of an example embodiment of an apparatus according to the present subject matter;

FIG. 2 shows a flow chart illustrating steps of an example embodiment of a method according to the present subject matter for the operation of a digitizer; and

FIG. 3 shows a schematic illustration of an example embodiment of a means of transport according to the present subject matter.

### DETAILED DESCRIPTION OF THE DRAWINGS

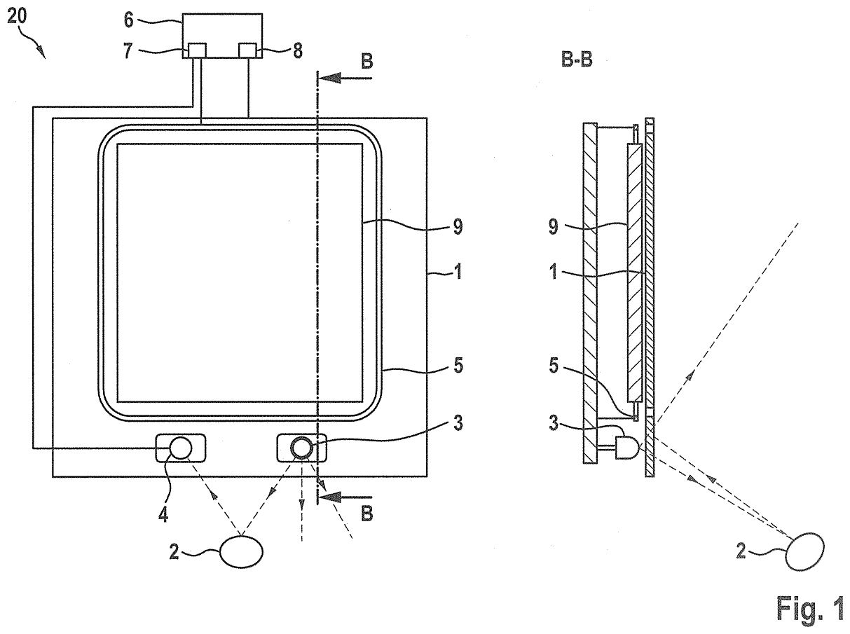

FIG. 1 shows an example embodiment of an apparatus 20 according to the present subject matter, having a digitizer 1 and, located behind it, a screen 9. The digitizer 1 serves for operating a GUI, presented on the screen 9, in an operating mode. In time intervals during which the user does not interact with the apparatus 20, the digitizer 1 and also the screen 9 are set to a sleep mode and then not supplied with electric power. Only an infrared LED 3, an infrared sensor 4, and a capacitive sensor 5 are capable, as a proximity sensor system, in the sleep state to locate the finger 2 of the user in a predefined proximity in front of the digitizer 1. In other words, the infrared sensor 5 and the capacitive sensor 5 are able to ascertain that the normal distance of the finger 2 from the digitizer 1 has reached or undershot a predefined value. The electronic control device 6 is configured as an evaluation unit via a data input 7 to ascertain the predefined proximity of the finger 2 and, as a reaction thereto, to transition the digitizer 1 and the screen 9 from the sleep mode into the operating mode. In this state, the user can perform inputs on the digitizer 1 based on touch using their finger 2 for operating the screen 9. The digitizer 1 and the screen 9 are thus transitioned from sleep mode into the operating mode not only as a reaction to a touch by the finger 2, with the result that the user can orient themselves on the screen 9 even before touching the digitizer 1 and the electronic control device 6 can prepare the startup of the digitizer 1 to make possible the shortest possible delay of the touch-based operation of the apparatus 20 on the part of the user.

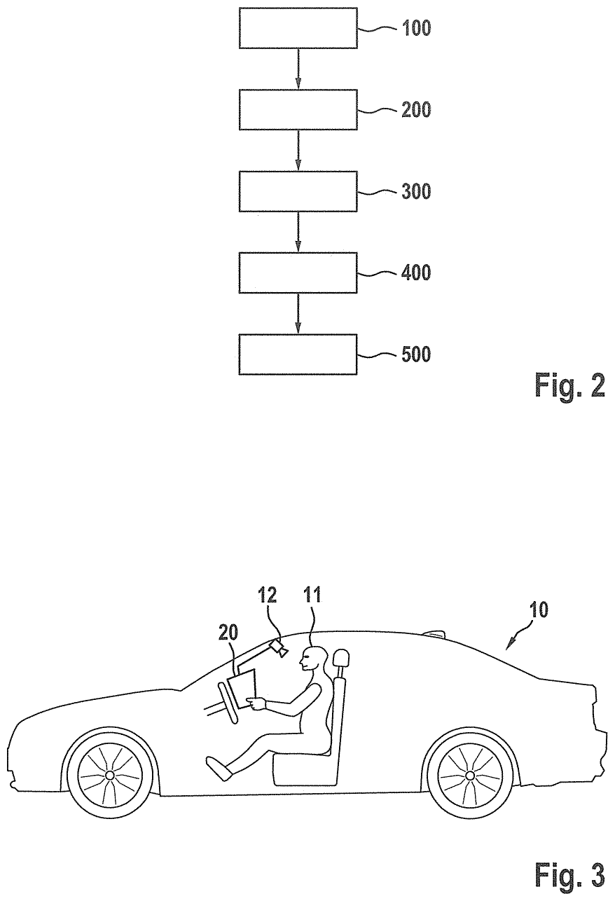

FIG. 2 shows steps of an example embodiment of a method according to the present subject matter for the operation of a digitizer. In step 100, a predefined proximity of an input medium to the digitizer is ascertained without contact with the digitizer by means of a proximity sensor. In step 200, the digitizer is transitioned as a reaction thereto from a sleep mode with reduced power consumption into a performance-oriented operating mode. In step 300, a touch-based user input on the digitizer is ascertained and, in step 400, associated with a graphical operating element (“button”). In step 500, a function that is associated with the button is called.

FIG. 3 shows an example embodiment of a means of transport according to the present subject matter in the form of a passenger car 10, in which a user 11 operates an example embodiment of an apparatus according to the present subject matter. A proximity sensor 12 in the form of an optical camera, which is connected for information transfer to the apparatus 20, is arranged in a roof operating module. Even before the user 11 touches the apparatus 20, the camera 12 makes it possible to ascertain a distance of the user 11 from the apparatus 20 being undershot (“approach” or “proximity”) and in this way enables the apparatus 20 to prepare a touch-based operation on the part of the user 11.

The proximity sensor can be embodied, for example, capacitively in the region of the digitizer (e.g. as a surrounding sensor system or in the peripheral region of the digitizer). Alternatively, or additionally, the proximity sensor system can have an optical implementation (e.g. via an infrared sensor system next to and/or below and/or above the display).

The method according to the present subject matter results in timely waking of the user interface to enable only a short waiting time, or no waiting time at all, until the actual operation via touch-based inputs for the user. The apparatus according to the present subject matter is ideally already active when the user touches the apparatus/the digitizer. It is possible to reduce the average power consumption of a user interface with a design according to the present subject matter compared to the prior art.

### LIST OF REFERENCE SIGNS

1 Digitizer
2 Finger (of the user)
3 Infrared LED
4 Infrared sensor
5 Capacitive sensor
6 Electronic control device
7 Data input
8 Data output
9 Screen
10 Passenger car
11 User
12 Camera
20 Apparatus
100 to 500 Method steps

1.-10. (canceled)

11. A method for operating a digitizer comprising a touch-sensitive input area, comprising the steps of:
ascertaining an approach by an input medium toward the digitizer without contact with the digitizer via an optical sensor, and in response:
switching the operational state of the digitizer from a sleep mode to an operating mode.

12. The method according to claim 11, wherein
the sleep mode is an operational state without any power consumption by the digitizer.

13. The method according to claim 11, wherein
the approach is additionally ascertained using a capacitive sensor.

14. The method according to claim 11, wherein
the digitizer is transparent, and
a screen is disposed behind the digitizer.

15. The method according to claim 11, wherein
a decorative interior surface of a vehicle is arranged behind or in front of the digitizer.

16. The method according to claim 11, wherein
the digitizer has a surface that is embodied to be concave and/or convex.

17. An apparatus for the operation of a digitizer, comprising:
a data input,
an evaluation unit, and
a data output, wherein
the evaluation unit is configured, in connection with the data input, to ascertain an approach by an input medium toward the digitizer without contact with the digitizer via an optical sensor, and
the evaluation unit is configured to transition the digitizer, in connection with the data output and in response to the data input, from a sleep mode to an operating mode.

18. A system for operating a digitizer comprising a touch-sensitive input area, comprising:
a data input;
a data output;
a processor;
a memory in communication with the processor, the memory storing a plurality of instructions executable by the processor to cause the system to:
ascertain, in connection with the data input, an approach by an input medium toward the digitizer without contact with the digitizer via an optical sensor, and in response:
switch the operational state of the digitizer, in connection with the data output and in response to the data input, from a sleep mode to an operating mode.

19. A vehicle comprising the apparatus according to claim 17.

20. The vehicle according to claim 19, further comprising:
a digitizer connected for information transfer to the data input and the data output, wherein
the digitizer is disposed on or in:
a dashboard,
a center console,
a multifunction steering wheel, and/or
an interior door trim.
